(19) United States
(12) Patent Application Publication
(10) Pub. No.: US 2006/0113227 A1
(43) Pub. Date: Jun. 1, 2006

(54) One-piece flow control valve for fluid filter assembly

(76) Inventor: Darrell T. Mckenzie, Gastonia, NC (US)

Correspondence Address: BERENATO, WHITE & STAVISH, LLC, 6550 ROCK SPRING DRIVE, SUITE 240, BETHESDA, MD, 20817, US

(21) Appl. No.: 10/999,061

(22) Filed: Nov. 30, 2004

(51) Int. Cl. B01D 21/24

(52) U.S. Cl. 210/130; 210/136; 210/420; 210/429; 210/433.1

(57) ABSTRACT

A fluid filter assembly comprises a casing, an end plate closing off the casing, a filter element disposed within the casing, and a one-piece flow control valve combining functions of a pressure relief valve and an anti-drainback valve. The end plate has a central outlet opening and an inlet opening radially spaced from the central outlet opening. The annular filter element divides the casing into an inlet chamber communicating with the inlet opening and an outlet chamber communicating with the central outlet. The fluid filter assembly further includes at least one bypass passage fluidly connecting the inlet chamber to the outlet chamber. The flow control valve has a single-piece valve body made of a resilient material and includes an anti-drainback valve, a central opening therethrough normally closed by the anti-drainback valve and a bypass valve normally closing the at least one bypass passage.

### BACKGROUND OF THE INVENTION

1. Field of the Invention

The present invention relates to fluid filters in general, and more particularly to a fluid filter including a flow control valve.

2. Description of the Prior Art

Fluid filters are widely used to filter liquids and gases to remove contaminents therefrom. For example, spin-on type filters are commonly used to filter engine oil in an automotive vehicle. Such filters are commonly provided with a pressure relief valve that permits the fluid to by-pass a filter element if it becomes clogged with the contaminants. When open, the pressure relief valve permits direct fluid communication between a filter inlet and outlet when the filter becomes clogged, so that the vehicle engine will not be starved for lubrication. The filters are also often provided with a drain-back valve that traps fluid in the filter and prevents it leaking out of the filter, e.g. when the vehicle engine is turned off.

Some conventional fluid filters include both the pressure relief valve and anti-drainback valve. However, currently used pressure relief and anti-drainback valves are made of large number of separate parts that makes them expensive in manufacturing and laborious and difficult to assemble.

Therefore, the fluid filters, including but not limited to those discussed above, are susceptible to improvements that may enhance their performance and cost. With this in mind, a need exists to develop improved pressure relief and anti-drainback valves for fluid filters that advance the art.

### SUMMARY OF THE INVENTION

The present invention provides a novel one-piece fluid flow valve for a fluid filter assembly and the like. The fluid filter assembly valve in accordance with the preferred embodiment of the present invention comprises a casing, an end plate closing off the casing, a filter element disposed within the casing, and a one-piece flow control valve combining functions of a pressure relieve valve and an anti-drainback valve. The end plate has a central outlet opening and at least one inlet opening radially spaced from the central outlet opening. The annular filter element divides the casing into an inlet chamber communicating with the at least one inlet opening and an outlet chamber communicating with the central outlet. The flow control valve has a single-piece valve body made of a resilient material and defining a central opening normally closed by the anti-drainback valve. The valve body further includes a resilient flap portion extending radially outwardly from the valve body. The valve body further defines at least one bypass passage between the inlet chamber and the outlet chamber normally closed by the flap portion. The flap portion deflects to uncover the at least one bypass passage when the filter element is clogged so that fluid can flow from the inlet chamber to the outlet chamber through the at least one bypass passage and through the central opening in the single-piece valve body to bypass the clogged filter.

Therefore, the one-piece self-venting drain valve in accordance with the present invention provides a one-piece flow control valve combining functions of a pressure relieve valve and an anti-drainback valve, and also serves for supporting the filter element within the filter casing. The one-piece flow control valve of the present invention is simple, inexpensive to manufacture and easy to install because of the simplicity of its design that is a significant improvement over prior art valves.

Upon further study of the specification and appended claims, further features and advantages of this invention will become apparent to those skilled in the art.

### BRIEF DESCRIPTION OF THE DRAWINGS

Other objects and advantages of the invention will become apparent from a study of the following specification when viewed in light of the accompanying drawings, wherein:

FIG. 1 is a cross-sectional view of a filter assembly of the present invention;

FIG. 2 is a cross-sectional view of a filter casing and a filter element of the filter assembly of the present invention;

FIG. 3 is a perspective view of a one-piece flow control valve according to the preferred embodiment of the present invention;

FIG. 4 is a cross-sectional view of the one-piece flow control valve according to the preferred embodiment of the present invention;

FIG. 5 is a cross-sectional view of filter assembly of the present invention showing flow of fluid through the filter assembly during the normal operation;

FIG. 6 is a cross-sectional view of filter assembly of the present invention showing flow of fluid through the filter assembly when the filter element is clogged.

### DETAILED DESCRIPTION OF PREFERRED EMBODIMENTS

The preferred embodiment of the present invention will now be described with the reference to accompanying drawings. In the present description of the preferred embodiment, certain terminology will be used for descriptive purposes only and is not intended to be limiting. The terms “upper”, “lower”, “top”, “bottom”, “right” and “left” designate directions in the drawings to which reference is made. The words “inward” and “outward” refer, respectively, to directions toward and away from the geometric center of the device and designated parts thereof. However, it is to be understood that the invention may assume various alternative orientations, except where expressly specified to the contrary. The terminology includes the words specifically mentioned above, derivatives thereof and words of similar import.

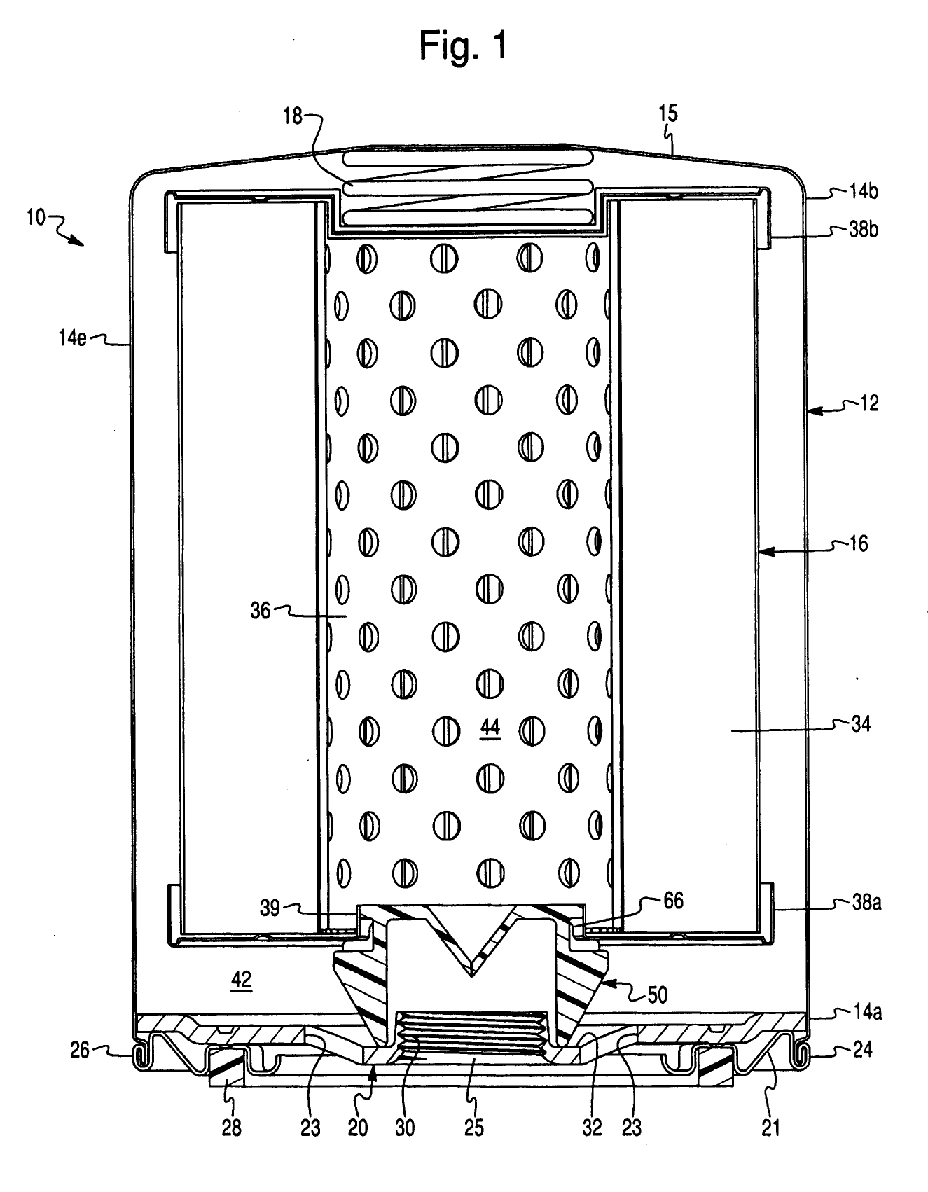

FIG. 1 depicts a fluid filter assembly 10 of a spin-on type such as used to filter engine-lubricating oil in a motor vehicle, to which the present invention can be applied. However, it is to be understood that while the present invention is described in relation to the spin-on type engine oil filter assembly, the present invention is equally suitable for use in any appropriate fluid filter assembly adapted to filter various fluids.

Referring now to FIGS. 1, 2 and 3, the filter assembly 10, to which the present invention can be applied, includes a cup-shaped casing (or canister) 12, a substantially cylindrical filter element 16 encased in the casing 12, and an annular end plate 20 closing off a lower open end of the casing 12. The filter casing 12 of the filter assembly 10 has a first end 14a and a second end 14b, and is formed by a substantially cylindrical side wall 14c open at the first end 14a of the filter housing 12 and closed at the second end 14b thereof by an end wall 15 formed unitary with the side wall 14c at the second end 14b of the filter housing 12.

The filter element 16 is biased by a coil spring 18 to seat against the end plate 20. The end plate 20 is retained within the lower end 14a of the casing 12 by a retainer plate 21 disposed against the bottom of the end plate 20. The annular retainer plate 21 is provided with an outwardly and upwardly turned lip 24 rolled over a complementary lip 26 disposed on the lower end of the casing 12 so as to form a rolled seam. An annular, resilient gasket 28 is disposed within a complementary annular recess in the retainer plate 21 so as to form a liquid tight seal against a cylinder block of an engine when the filter assembly 10 is secured thereto.

A central portion of the end plate 20 is provided with an internally threaded sleeve 30 defining a central outlet opening (or port) 25 therein. The central portion of the end plate 20 is also provided with a substantially horizontal, flat, annular shelf 32 around the threaded sleeve 30 and at least one fluid inlet opening (or port) 23. Preferably, the end plate 20 has a plurality of circumferentially spaced fluid inlet openings 23. As illustrated in FIG. 1, the inlet openings 23 are formed radially outwardly of the threaded sleeve 30 and the annular shelf 32, and radially inwardly of the gasket 28.

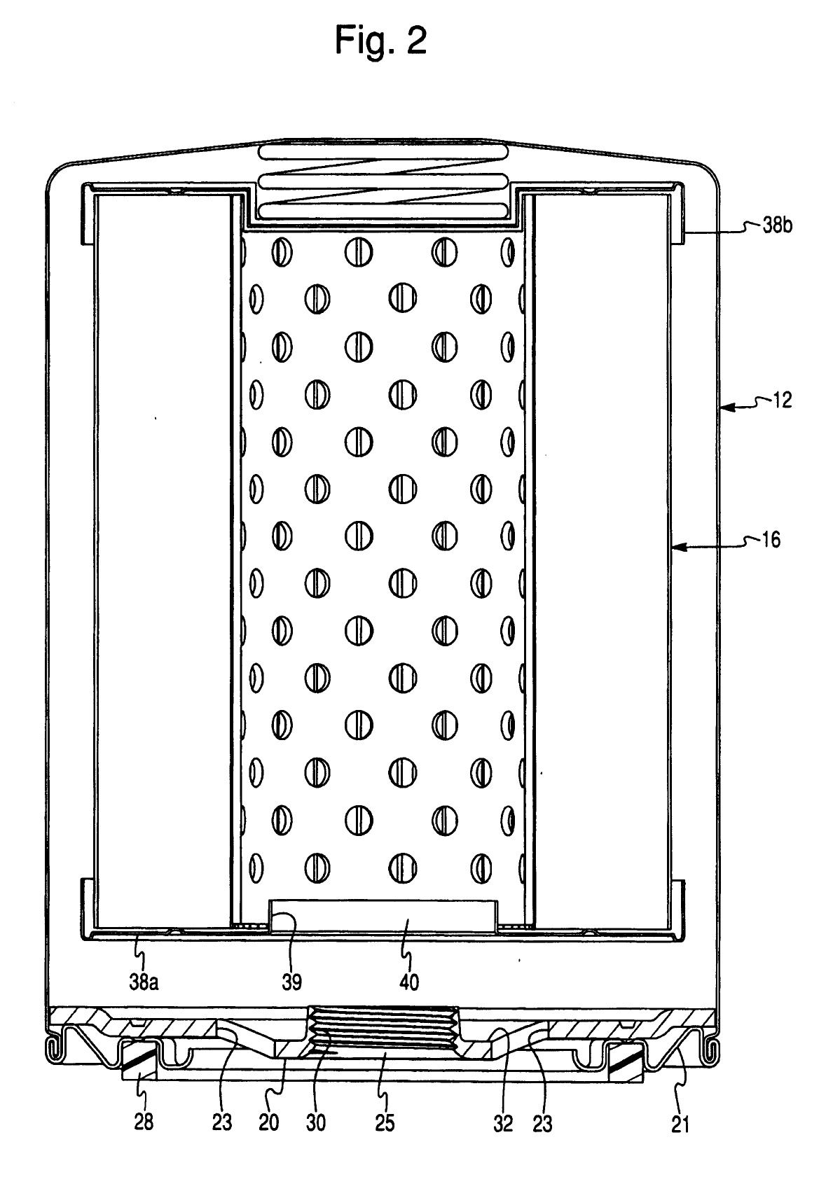

The filter element 16 includes a filter media 34 disposed around a perforated center tube (or hollow core) 36, and end caps 38a and 38b sealing off opposite ends of the filter media 34 at. Preferably, the filter media 34 is in the form of a conventional pleated paper filter material disposed around the perforated center tube 36. It will be appreciated that any other appropriate filter material will be within the scope of the present invention. As further illustrated in detail in FIG. 2, the lower end cap 38a has a substantially annular inner flange 39 defining an aperture 40 in the lower end cap 38a. The upper end cap 38b closes off an upper end of the hollow core 36 and is formed with a recess receiving the spring 18 so as to maintain the filter element 16 in a seated position in the filter casing 12.

The annular filter element 16 divides a cavity within the filter housing 12 into an inlet chamber 42 (a space within the filter housing 12 and outside the filter element 16) communicating with the inlet openings 23 and an outlet chamber 44 (a space within the hollow core 36 of the filter element 16) communicating with the central outlet opening 25. It will be appreciated that the inlet chamber 42 defines a dirty side of the filter assembly 10, while the outlet chamber 44 defines a clean side thereof.

The filter assembly 10 of the present invention further comprises a one-piece flow control valve 50 combining functions of a pressure relieve (or bypass) valve and an anti-drainback valve. The flow control valve 50 also serves for supporting the filter element 16 within the casing 12 between the end plate 20 and the spring 18.

The flow control valve 50 is made of a resilient (or elastic) material, such as rubber or rubber-like material, as a single-piece member and, in assembled condition, is mounted within the lower end cap 38a of the filter element 16 as best illustrated in FIGS. 1, 5 and 6. The one-piece flow control valve 50 is sandwiched between the filter element 16 and the end plate 20 and biased by the coil spring 18 through the filter element 16 to seat against the end plate 20.

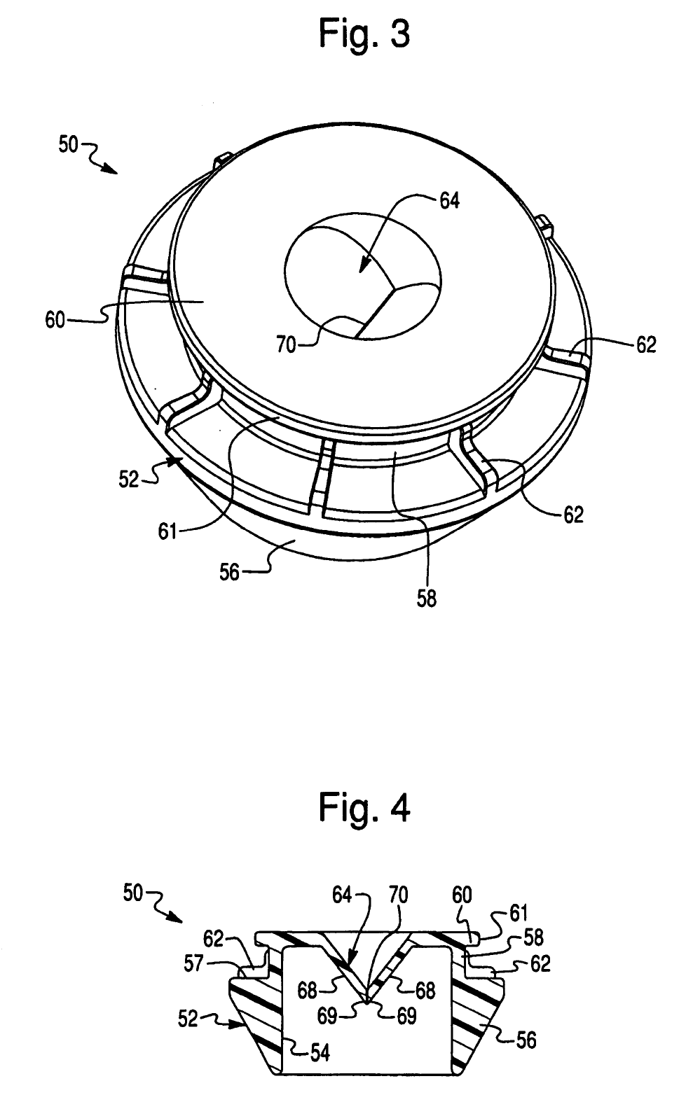

As illustrated in detail in FIGS. 3 and 4, the one-piece flow control valve 50 comprises a substantially annular, single-piece valve body 52 defining a central opening 54 therethrough and including a support portion 56, a collar portion 58 extending from the support portion 56, an annular flap portion 60 radially outwardly extending from the collar portion 58 and serving as a bypass valve, a plurality of substantially L-shaped ribs 62 outwardly extending from the support portion 56, and an anti-drainback valve generally designated 64. Alternatively, the ribs 62 may be provided on an outer peripheral surface of the lower end cap 38a. Preferably, the single-piece valve body 52 is made of a substantially homogenous resilient material.

The distal end of the support portion 56 is seated on the shelf 32 of the end plate 20 so as to form a fluid-tight seal with the end plate 20 to prevent fluid communication between the inlet chamber 42 and the outlet chamber 44.

The lower end cap 38a of the filter element 16 is supported by the ribs 62 outwardly extending from a support surface 57 of the support portion 56 so as to form at least one, but preferably a plurality of bypass passages 66 between the lower end cap 38a of the filter element 16 and the ribs 62 of the body 52 of the flow control valve 50 and the flange 39 of the cap 38a and the collar portion 58.

Normally, an outer peripheral surface 61 of the flap portion 60 sealing engages the inner flange 39 of the lower end cap 38a to prevent fluid communication between the inlet chamber 42 and the outlet chamber 44 through the bypass passages 66.

The anti-drainback valve 64 has a general configuration of a duckbill, or slit-diaphragm valve. As illustrated in detail in FIGS. 3 and 4, the anti-drainback valve 64 is provided with two substantially planar or flat sides 68 having distal lip portions 69 that converge to a slit 70 through which the fluid can flow only in the direction from the outlet chamber 44 to the central outlet port 25. Normally, the distal lip portions 69 of the flat sides 68 sealingly engage each other.

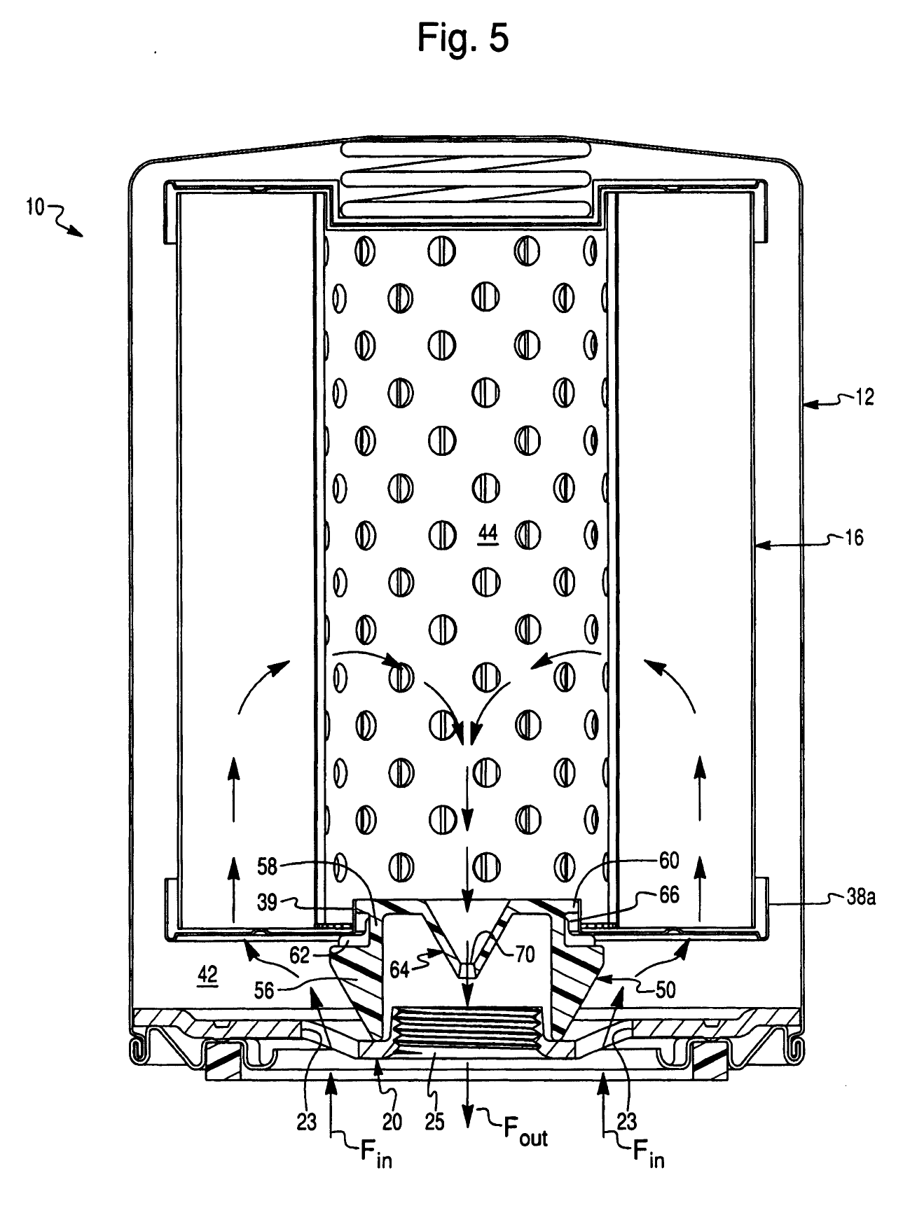

During normal operation, illustrated in FIG. 5, the fluid to be filtered such as lubricating oil, represented by arrows F_{IN}, flows through the inlet ports 23 into the inlet chamber 42 within the filter casing 12. From the inlet chamber 42 the fluid flows in an outside-in direction through the filter media 34 of the filter element 16 into the outlet chamber 44. The filter element 16 removes any contaminants carried in the fluid stream. Then, the filter fluid, represented by arrows F_{OUT}, exits the outlet chamber 44 of the fluid filter assembly 10 through the anti-drainback valve 64 of the flow control valve 50 and through the central outlet port 25 in the endplate 20. While exiting the fluid filter assembly 10, the fluid pressure forces the flat sides 68 of the anti-drainback valve 64 to separate from each other, thus opening the slit 70 and permitting the fluid to pass through the anti-drainback valve 64 into the central opening 54 in the flow control valve 50 and out of the filter assembly 10 through the central outlet port 25. The duckbill configuration of the flexible anti-drainback valve 64 permits fluid to flow only in one direction theretrough since the resilient force acting on the flat sides 68 of the anti-drainback valve 64 closes the slit 70 when there is no forced fluid flow through the anti-drainback valve 64 in the direction from the outlet chamber 44 to the central outlet port 25. At such instance, the lip portions 69 of the flat sides 68 return to their original position to close the slit 70 and form a tight seal preventing the fluid flow through the anti-drainback valve 64. It will be appreciated that the configuration of the duckbill valve does not require a biasing spring or any other means to return the flat sides 68 of the anti-drainback valve 64 to a closed position, but the inherent characteristics of the valve 64 and its configuration causes the anti-drainback valve 64 to be normally maintained in the closed position when there is no fluid flow through the filter assembly 10.

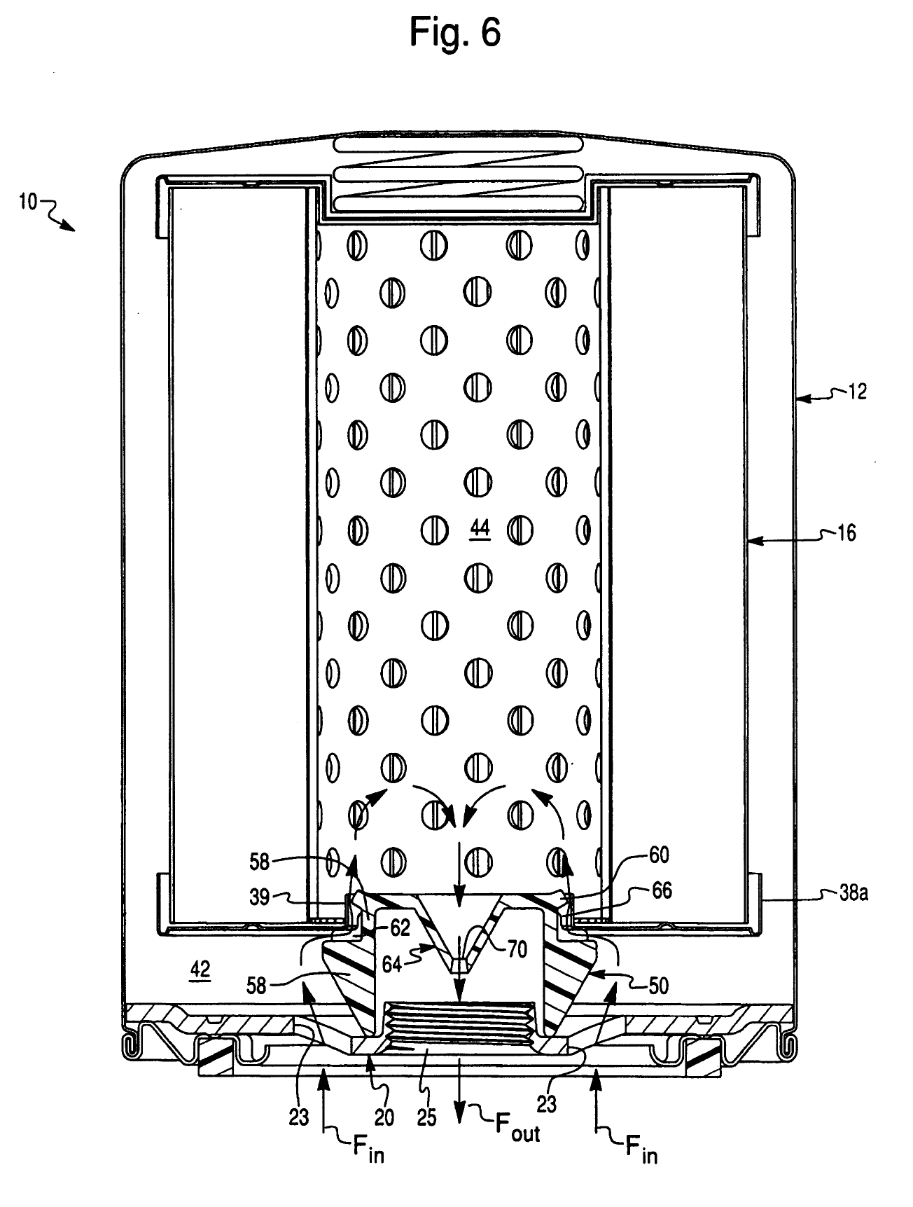

When the filter element 16 becomes clogged so that the fluid pressure entering the fluid inlet ports 23 exceeds that within the outlet chamber 44 because of the restricted flow through the filter media 34, the fluid pressure differential between the inlet ports 23 and the outlet port 25 causes the flap portion 60 of the flow control valve 50 to deflect into the outlet chamber 44, thus opening the bypass passages 66 to permit direct fluid communication between the inlet chamber 42 and the outlet chamber 44. The opening of the bypass passages 66 allows the fluid entering the inlet ports 23 to pass through the fluid bypass passages 66 into the outlet chamber 44 bypassing the filter element 16 and out of the filter assembly 10 through the central outlet port 25, as shown in FIG. 6.

When the filter assembly 10 is not operating, the anti-drainback valve 64 of the flow control valve 50 prevents fluid from leaking from the outlet chamber 44 through the central outlet port 25. In other words, the anti-drainback valve 64 is defined as the “clean side” anti-drainback valve.

Therefore, the one-piece self-venting drain valve in accordance with the present invention provides a one-piece flow control valve made of a substantially homogenous resilient material and combining functions of a pressure relieve valve and an anti-drainback valve, also serves for supporting the filter element within the filter casing. The one-piece flow control valve of the present invention is simple, inexpensive to manufacture and easy to install because of the simplicity of its design that is a significant improvement over prior art valves.

The foregoing description of the preferred embodiments of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the present invention be defined by the claims appended thereto.

What is claimed is:

1. A fluid filter assembly for filtering a fluid, said filter assembly comprising:
a filter casing and an end plate closing off said filter casing, said end plate having a central outlet opening therethrough and at least one inlet opening radially spaced from said central outlet opening;
a filter element disposed within said filter casing, said filter element dividing said casing into an inlet chamber communicating with said at least one inlet opening and an outlet chamber communicating with said central outlet;
at least one bypass passage between said inlet chamber and said outlet chamber; and
a one-piece flow control valve having a single-piece valve body made of a substantially resilient material;
said single-piece valve body including an anti-drainback valve, a central opening therethrough normally closed by said anti-drainback valve and a bypass valve normally closing said at least one bypass passage to prevent fluid communication between said inlet chamber and said outlet chamber through said at least one bypass passage and opening said at least one bypass passage when said filter element is clogged so that fluid can flow from said inlet chamber to said outlet chamber.

2. The fluid filter assembly as defined in claim 1, wherein said bypass valve includes a resilient flap portion extending radially outwardly from said valve body so that said flap portion normally covers said at least one bypass passage and deflects to uncover said at least one bypass passage when said filter element is clogged so that fluid can flow from said inlet chamber to said outlet chamber through said at least one bypass passage and through said central opening in said single-piece valve body to bypass said clogged filter element.

3. The fluid filter assembly as defined in claim 2, wherein said filter element has a hollow core and is supported by opposite end caps.

4. The fluid filter assembly as defined in claim 3, wherein one of said end caps having a central opening therethrough, and wherein said resilient flap portion of said one-piece flow control valve normally sealingly engages said central opening in one of said end caps of said filter element.

5. The fluid filter assembly as defined in claim 1, wherein said single-piece valve body of said flow control valve is disposed between said end plate and said filter element.

6. The fluid filter assembly as defined in claim 1, wherein said filter casing is substantially cylindrical and said filter element is substantially annular in shape.

7. The fluid filter assembly as defined in claim 1, wherein said single-piece valve body of said flow control valve is further provided to support said filter element within said filter casing adjacent to said end plate.

8. The fluid filter assembly as defined in claim 1, wherein said anti-drainback valve of said one-piece flow control valve is in the form of a slit-diaphragm valve comprising two planar converging sides provided with a slit at their point of convergence.

9. The fluid filter assembly as defined in claim 1, wherein said filter element is biased toward said endplate by a spring element disposed between a closed end of said filter casing and said filter element to seat against said end plate.

10. The fluid filter assembly as defined in claim 1, wherein said single-piece valve body of said flow control valve further includes a support portion sandwiched between said filter element and said end plate.

11. The fluid filter assembly as defined in claim 10, wherein said single-piece valve body of said flow control valve further includes a plurality of ribs outwardly extending from said support portion so as to form a plurality of bypass passages between said filter element and said single-piece valve body, said bypass passages providing direct fluid communication between said inlet and outlet chambers bypassing said filter element.

12. The fluid filter assembly as defined in claim 11, wherein said bypass valve of said single-piece valve body normally closes said bypass passages to prevent fluid communication between said inlet chamber and said outlet chamber through said bypass passages.

13. The fluid filter assembly as defined in claim 12, wherein said bypass valve includes a resilient flap portion extending radially outwardly from said valve body so that said flap portion normally covers said bypass passages and deflects to uncover said bypass passages when said filter element is clogged so that fluid can flow from said inlet chamber to said outlet chamber through said bypass passages and through said central opening in said single-piece valve body to bypass said clogged filter element.

14. The fluid filter assembly as defined in claim 13, wherein said filter element has a hollow core and is supported by opposite end caps.

15. The fluid filter assembly as defined in claim 14, wherein one of said end caps having an inner flange forming a central opening therethrough, and wherein said resilient flap portion of said one-piece flow control valve normally sealingly engages said inner flange to close said bypass passages.

16. The fluid filter assembly as defined in claim 15, wherein said single-piece valve body further includes a collar portion adjacent to said resilient flap portion, and wherein said collar portion disposed within said central opening through one of said end caps; said bypass passages are provided in a space between said collar portion and said inner flange of one of said end caps.

17. A one-piece flow control valve for a fluid filter assembly including a filter casing, an end plate closing off said filter casing and a filter element disposed within said filter casing, said end plate having a central outlet opening therethrough and at least one inlet opening radially spaced from said central outlet opening, said filter element dividing said casing into an inlet chamber communicating with said at least one inlet opening and an outlet chamber communicating with said central outlet, said fluid filter assembly further including at least one bypass passage fluidly connecting said inlet chamber to said outlet chamber, said flow control valve comprising:
a single-piece valve body made of a substantially resilient material;
said single-piece valve body including an anti-drainback valve, a central opening therethrough normally closed by said anti-drainback valve and a bypass valve normally closing said at least one bypass passage to prevent fluid communication between said inlet chamber and said outlet chamber through said at least one bypass passage and opening said at least one bypass passage when said filter element is clogged so that fluid can flow from said inlet chamber to said outlet chamber.

18. The fluid filter assembly as defined in claim 17, wherein said bypass valve includes a resilient flap portion extending radially outwardly from said valve body so that said flap portion normally covers said at least one bypass passage and deflects to uncover said at least one bypass passage when said filter element is clogged so that fluid can flow from said inlet chamber to said outlet chamber through said at least one bypass passage and through said central opening in said single-piece valve body to bypass said clogged filter element.

19. The fluid filter assembly as defined in claim 18, wherein said single-piece valve body of said flow control valve further includes a support portion sandwiched between said filter element and said end plate.

20. The fluid filter assembly as defined in claim 21, wherein said single-piece valve body of said flow control valve further includes a plurality of ribs outwardly extending from said support portion so as to form a plurality of bypass passages between said filter element and said single-piece valve body, said bypass passages providing direct fluid communication between said inlet and outlet chambers bypassing said filter element.

21. The fluid filter assembly as defined in claim 20, wherein said the flap portion of said single-piece valve body normally closes said bypass passages to prevent fluid communication between said inlet chamber and said outlet chamber through said bypass passages.

22. The fluid filter assembly as defined in claim 21, wherein one of said end caps having an inner flange forming a central opening therethrough, and wherein said resilient flap portion of said one-piece flow control valve normally sealingly engages said inner flange to close said bypass passages.

23. The fluid filter assembly as defined in claim 22, wherein said single-piece valve body further includes a collar portion adjacent to said resilient flap portion, and wherein said collar portion disposed within said central opening through one of said end caps; said bypass passages are provided in a space between said collar portion and said inner flange of one of said end caps.
